(19) United States
(12) Patent Application Publication
(10) Pub. No.: US 2024/0187079 A1
(43) Pub. Date: Jun. 6, 2024

(54) IMPLICIT BEAM SWITCH

(71) Applicant: QUALCOMM Incorporated, San Diego, CA (US)

(72) Inventors: Fang YUAN, Beijing (CN); Yan ZHOU, San Diego, CA (US); Chenxi HAO, Beijing (CN); Tao LUO, San Diego, CA (US)

(21) Appl. No.: 18/553,936

(22) PCT Filed: Jun. 9, 2021
(86) PCT No.: PCT/CN2021/099092

§ 371 Date: Oct. 4, 2023

(51) Int. Cl. H04B 7/06

(52) U.S. Cl. CPC H04B 7/06952

(57) ABSTRACT

Various aspects of the present disclosure generally relate to wireless communication. In some aspects, a user equipment (UE) may receive an indication that beam switching without an explicit beam indication or activation is allowed. The UE may transmit a channel state information (CSI) report identifying a selected beam. The UE may selectively switch to the selected beam in accordance with the indication. Numerous other aspects are described.

### FIELD OF THE DISCLOSURE

Aspects of the present disclosure generally relate to wireless communication and to techniques and apparatuses for implicit beam switch.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station. The above multiple access technologies have been adopted in various

telecommunication standards to provide a common protocol that enables different UEs to communicate on a municipal, national, regional, and/or global level. NR, which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving an indication that beam switching without an explicit beam indication or activation is allowed. The method may include transmitting a channel state information (CSI) report identifying a selected beam. The method may include selectively switching to the selected beam in accordance with the indication.

Some aspects described herein relate to a method of wireless communication performed by a base station. The method may include transmitting, to a UE, an indication that beam switching without an explicit beam indication or activation is allowed. The method may include receiving a CSI report identifying a selected beam. The method may include selectively switching to the selected beam in accordance with the indication.

Some aspects described herein relate to an apparatus for wireless communication at a UE. The apparatus may include a memory. The apparatus may include one or more processors, coupled to the memory, configured to receive an indication that beam switching without an explicit beam indication or activation is allowed. The one or more processors may be configured to transmit a CSI report identifying a selected beam. The one or more processors may be configured to selectively switch to the selected beam in accordance with the indication.

Some aspects described herein relate to an apparatus for wireless communication at a base station. The apparatus may include a memory. The apparatus may include one or more processors, coupled to the memory, configured to transmit, to a UE, an indication that beam switching without an explicit beam indication or activation is allowed. The one or more processors may be configured to receive a CSI report identifying a selected beam. The one or more processors may be configured to selectively switch to the selected beam in accordance with the indication.

Some aspects described herein relate to a non-transitory computer-readable medium that stores a set of instructions for wireless communication by a UE. The set of instructions, when executed by one or more processors of the UE, may cause the UE to receive an indication that beam switching without an explicit beam indication or activation is allowed. The set of instructions, when executed by one or more processors of the UE, may cause the UE to transmit a CSI report identifying a selected beam. The set of instructions, when executed by one or more processors of the UE, may cause the UE to selectively switch to the selected beam in accordance with the indication.

Some aspects described herein relate to a non-transitory computer-readable medium that stores a set of instructions for wireless communication by a base station. The set of instructions, when executed by one or more processors of the base station, may cause the base station to transmit, to a UE, an indication that beam switching without an explicit beam indication or activation is allowed. The set of instructions, when executed by one or more processors of the base station, may cause the base station to receive a CSI report identifying a selected beam. The set of instructions, when executed by one or more processors of the base station, may cause the base station to selectively switch to the selected beam in accordance with the indication.

Some aspects described herein relate to an apparatus for wireless communication. The apparatus may include means for receiving an indication that beam switching without an explicit beam indication or activation is allowed. The apparatus may include means for transmitting a CSI report identifying a selected beam. The apparatus may include means for selectively switching to the selected beam in accordance with the indication.

Some aspects described herein relate to an apparatus for wireless communication. The apparatus may include means for transmitting, to a UE, an indication that beam switching without an explicit beam indication or activation is allowed. The apparatus may include means for receiving a CSI report identifying a selected beam. The apparatus may include means for selectively switching to the selected beam in accordance with the indication.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of implicit beam switching based at least in part on an indication, in accordance with the present disclosure.

FIG. 4 is a diagram illustrating an example process performed, for example, by an apparatus of a UE, in accordance with the present disclosure.

FIG. 5 is a diagram illustrating an example process performed, for example, by an apparatus of a base station, in accordance with the present disclosure.

FIG. 6 is a diagram of an example apparatus for wireless communication, in accordance with the present disclosure.

FIG. 7 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

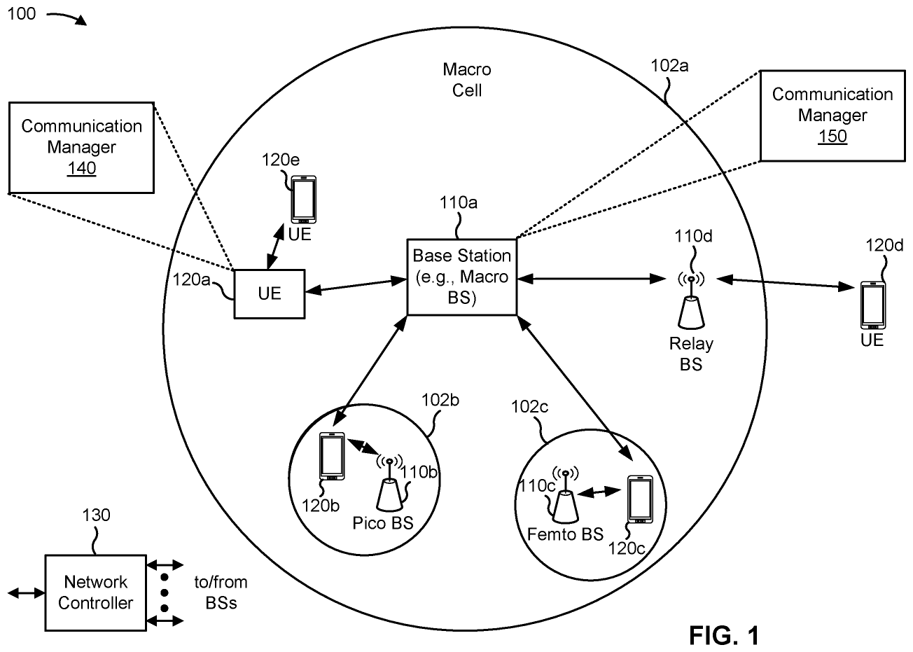

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a base station (BS) 110a, a BS 110b, a BS 110c, and a BS 110d), a user equipment (UE) 120 or multiple UEs 120 (shown as a UE 120a, a UE 120b, a UE 120c, a UE 120d, and a UE 120c), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz 7.125 GHZ) and FR2 (24.25 GHz 52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ 300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ 24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHZ. For example, three higher operating bands have been identified as frequency range designations FR4a or FR4-1 (52.6 GHZ 71 GHz), FR4 (52.6 GHZ 114.25 GHZ), and FR5 (114.25 GHZ 300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive an indication that beam switching without an explicit beam indication or activation is allowed; transmit a channel state information (CSI) report identifying a selected beam; and selectively switch to the selected beam in accordance with the indication. Additionally, or alternatively, the communication manager 140 may perform one or more other operations described herein.

In some aspects, the base station 110 may include a communication manager 150. As described in more detail elsewhere herein, the communication manager 150 may transmit, to a UE, an indication that beam switching without an explicit beam indication or activation is allowed; receive a CSI report identifying a selected beam; and selectively switch to the selected beam in accordance with the indication. Additionally, or alternatively, the communication manager 150 may perform one or more other operations described herein.

As indicated above, FIG. 1 is provided as an example. Other examples may differ from what is described with regard to FIG. 1.

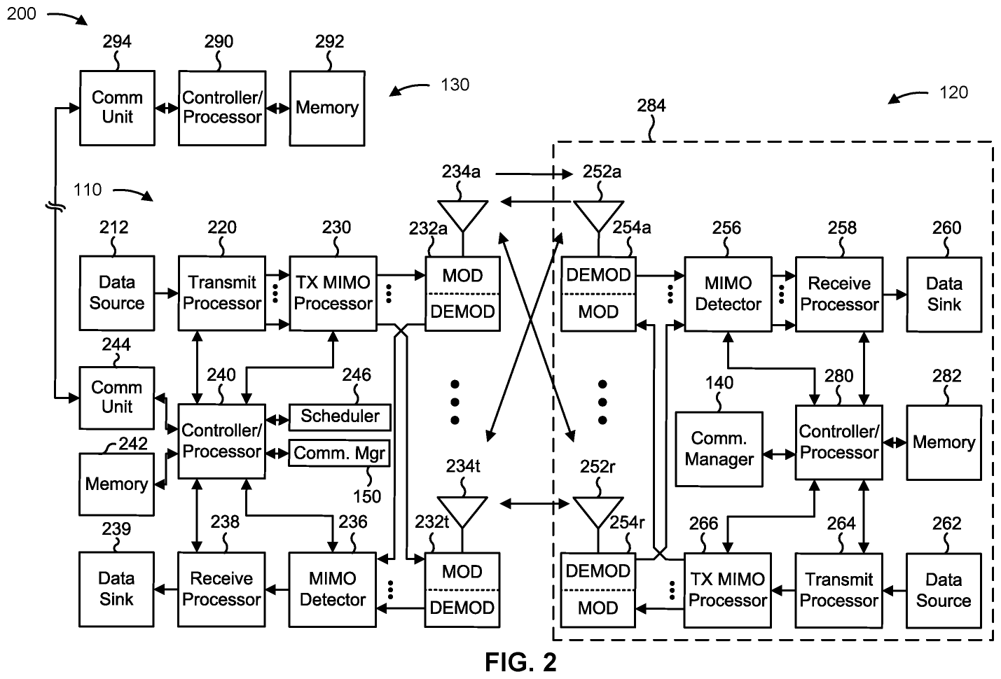

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

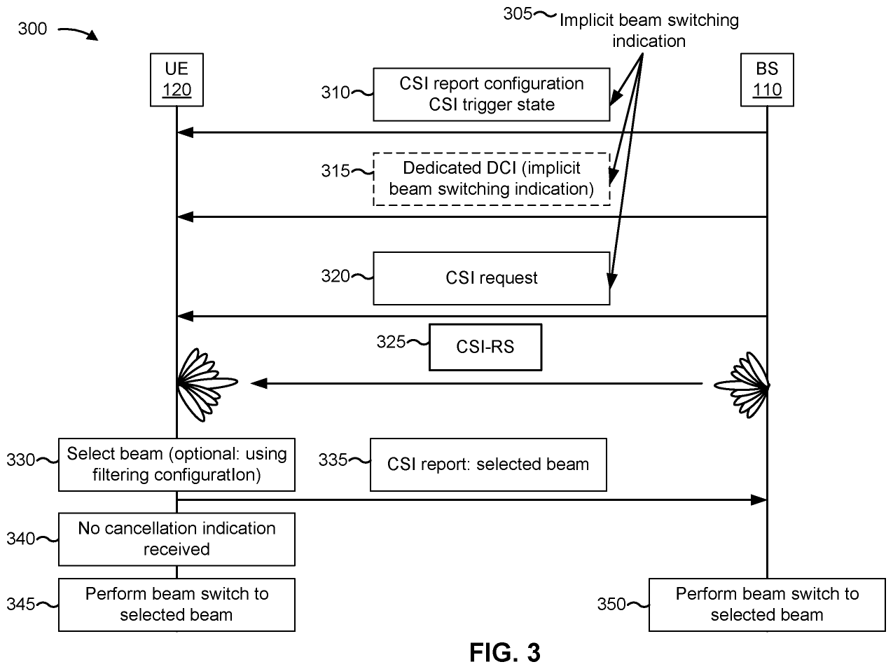

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-5).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-5).

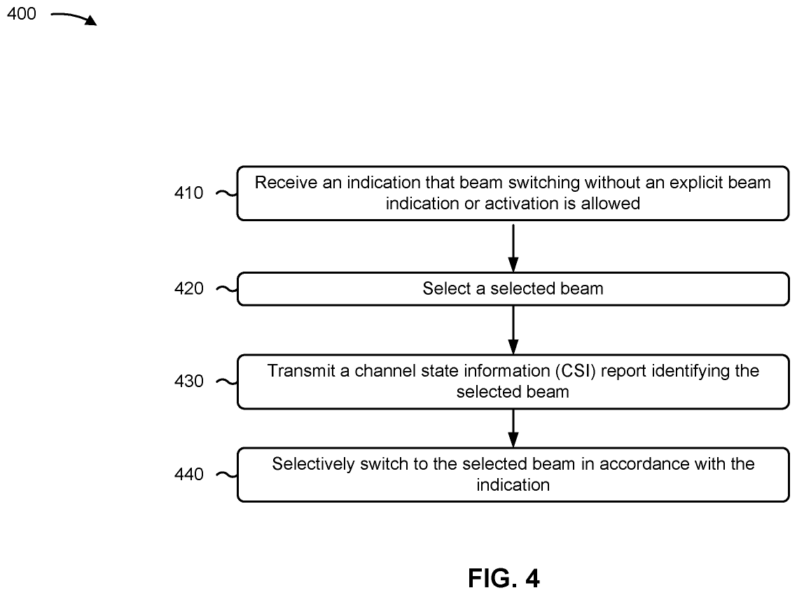

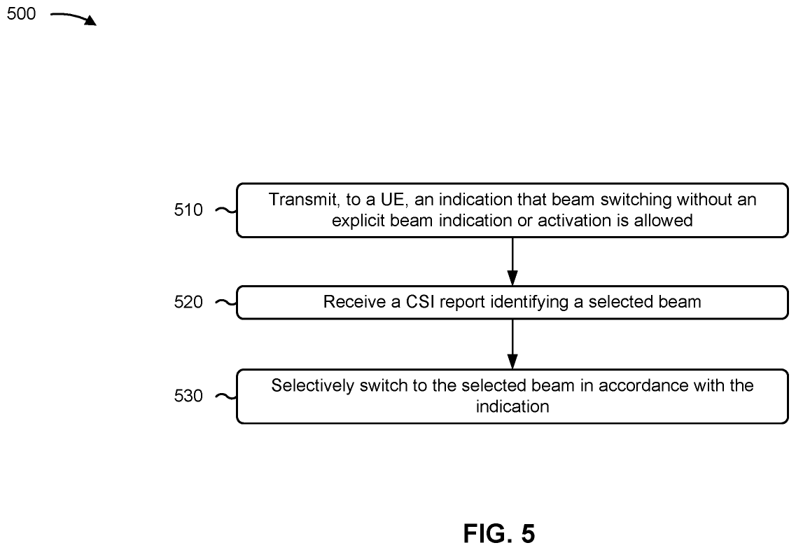

The controller/processor 240 of the base station 110, the controller/processor 280 of the UE 120, and/or any other component(s) of FIG. 2 may perform one or more techniques associated with implicit beam switching, as described in more detail elsewhere herein. For example, the controller/processor 240 of the base station 110, the controller/processor 280 of the UE 120, and/or any other component(s) of FIG. 2 may perform or direct operations of, for example, process 400 of FIG. 4, process 500 of FIG. 5, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 400 of FIG. 4, process 500 of FIG. 5, and/or other processes as described herein. In some examples, executing instructions may include running the instructions, converting the instructions, compiling the instructions, and/or interpreting the instructions, among other examples.

In some aspects, the UE includes means for receiving an indication that beam switching without an explicit beam indication or activation is allowed; means for transmitting a CSI report identifying a selected beam; and/or means for selectively switching to the selected beam in accordance with the indication. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting, to a UE, an indication that beam switching without an explicit beam indication or activation is allowed; means for receiving a CSI report identifying a selected beam; and/or means for selectively switching to the selected beam in accordance with the indication. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

A UE and a base station may communicate using beamforming. Beamforming provides for the generation of a transmit beam by a transmitter of a signal and a receive beam by a receiver of the signal. Beamforming provides improved gain for wireless communications, so long as a beam pair between the transmitter and the receiver can be reliably maintained.

Beams for a beam pair are selected and refined by way of a beam management procedure. A beam management procedure may include, for example, three stages: a P1 stage, sometimes referred to as beam selection; a P2 stage, sometimes referred to as beam refinement for the transmitter; and a P3 stage, sometimes referred to as beam refinement for the receiver. In the P1 stage, a base station may transmit a reference signal, such as a channel state information reference signal (CSI-RS) via a plurality of beams, such as using beam sweeping. A UE may perform measurements on the CSI-RS, may select a best downlink beam, and may provide a CSI report indicating the selected downlink beam. In the P2 stage, the base station may transmit CSI-RSs on a narrower set of beams than in the P1 stage for the purpose of refining the downlink beam used for communication with the UE. The UE may again select a best downlink beam and may report information indicating the best downlink beam to the base station. In the P3 stage, the UE may measure a selected downlink beam (e.g., the downlink beam indicated as part of the P1 stage and/or the P2 stage) using a plurality of downlink UE receive beams. The UE may identify a best receive beam, and may use the identified receive beam for communication with the base station. In some aspects, the UE may switch to the selected downlink beam based at least in part on a beam indication or activation received from the base station. In some aspects, one or more of the P1 stage, the P2 stage, or the P3 stage may be performed using a signal other than a CSI-RS, such as a synchronization signal/physical broadcast channel (SS/PBCH) block (SSB).

Implicit beam switching provides for a UE and a base station to skip the beam indication or activation associated with beam selection. A UE using implicit beam switching may perform beam switching without an explicit beam indication or activation. For example, the UE may select a downlink beam (such as at the P1 stage, the P2 stage, or the P3 stage) based at least in part on a CSI measurement and may transmit a CSI report identifying the selected downlink beam. Thereafter, the UE and the base station may switch to the selected downlink beam indicated by the CSI report without transmitting an explicit beam indication identifying the selected downlink beam. Thus, the UE and the base station may reduce latency and overhead associated with beam selection and refinement. However, not all base stations (and not all UEs) may support implicit beam switching. If a UE attempts to use implicit beam switching for a base station that does not support implicit beam switching, then the UE may experience a mismatch between the base station's downlink beam and the UE's downlink beam, which may lead to degraded communication performance and beam failure.

Furthermore, not all base stations may support implicit beam switching, and some base stations may switch between supporting and not supporting implicit beam switching (or a base station may support implicit beam switching for some UEs and not other UEs). These variations may create uncertainty in whether implicit beam switching is supported and in use for a given UE, which may lead to mismatched beams and, therefore, degraded communication performance and beam failure.

Some techniques and apparatuses described herein provide signaling indicating whether to perform implicit beam switching. For example, some techniques and apparatuses described herein provide for indication of whether a CSI report, transmitted by a UE, should be used for implicit beam switching. In various aspects described herein, this indication can be via a CSI report configuration, a CSI trigger state, a DCI field for a CSI request, or a dedicated DCI field. Some techniques and apparatuses described herein also provide beam cancellation for an implicit beam switch, time domain filtering for an implicit beam switch (e.g., for selection of the beam), channel applicability for the implicit beam switch, and triggering conditions for the implicit beam switch. In this way, communication performance is improved and the occurrence of beam failure is reduced. Furthermore, the techniques and apparatuses described herein allow increased flexibility for a base station to selectively use implicit beam switching by configuring or triggering certain UEs to perform implicit beam switching, which enables support for a combination of UEs that support implicit beam switching and UEs that do not support implicit beam switching.

FIG. 3 is a diagram illustrating an example 300 of implicit beam switching based at least in part on an indication, in accordance with the present disclosure. As shown in FIG. 3, example 300 includes a UE 120 in communication with a base station 110 in a wireless network (e.g., wireless network 100). However, the devices shown in FIG. 3 are provided as examples, and the wireless network may support communication and beam management between other devices (e.g., between a UE 120 and a base station 110 or transmit receive point (TRP), between a mobile termination node and a control node, between an integrated access and backhaul (IAB) child node and an IAB parent node, and/or between a scheduled node and a scheduling node). In some aspects, the UE 120 and the base station 110 may be in a connected state (e.g., an RRC connected state).

Example 300 relates to triggering implicit beam switching using an implicit beam switching indication 305. As mentioned above, implicit beam switching is beam switching without an explicit beam indication or activation from a base station 110. Implicit beam switching can be contrasted with beam switching using an explicit beam indication or activation, in which the base station 110 transmits, to the UE 120, information indicating a beam to which the UE 120 is to switch (for example, by indicating or activating a transmission configuration indicator (TCI) state associated with the beam for a downlink channel or reference signal, or by indicating or activating spatial relation information associated with the beam for a uplink channel or reference signal). A TCI state for a communication identifies one or more quasi-colocation (QCL) parameters and a source reference signal. The TCI state indicates that the one or more QCL parameters should be derived from the source reference signal and applied to the communication. A QCL parameter may include, for example, Doppler shift, Doppler spread, average delay, delay spread, and a spatial reception (or transmission) parameter.

The implicit beam switching indication 305 is an indication that beam switching without an explicit beam indication or activation is allowed. For example, the implicit beam switching indication 305 may indicate that the UE 120 can perform implicit beam switching, as described in more detail below. In some aspects, the implicit beam switching indication 305 may be included in or associated with a CSI report configuration (such as shown by reference number 310, and described in more detail below). For example, the CSI report configuration may include a field that provides the implicit beam switching indication 305. As another example, a rule may indicate that a particular CSI report configured by the CSI report configuration is associated with implicit beam switching (such as a CSI report with a lowest identifier), so the implicit beam switching indication 305 may be implicit in the CSI report configuration. In some aspects, the implicit beam switching indication 305 may be provided via radio resource control (RRC) configuration, medium access control control element (MAC-CE) selection, or the like (such as in association with one of the above examples or separately from one of the above examples). For example, the MAC-CE signaling may indicate a CSI report configuration and an implicit beam switching indication 305 to the UE 120. The UE 120 may perform implicit beam switching when indicated to perform CSI measurement or CSI report based at least in part on the CSI report configuration being associated with the implicit beam switching indicator.

In some aspects, the implicit beam switching indication 305 may be included in or associated with a CSI trigger state, which is also shown by reference number 310. A CSI trigger state may be configured so that a base station 110 can trigger a UE 120 to perform CSI reporting in accordance with at least one CSI report configuration. For example, a CSI trigger state may be associated with aperiodic CSI (A-CSI) reporting, in which one or more CSI reports are triggered by DCI, or semi-persistent CSI (SP-CSI) reporting, in which CSI reporting on a semi-persistent basis is activated by DCI or medium access control (MAC) signaling. In some aspects, a CSI trigger state may be configured with an implicit beam switching indication 305. Thus, when the CSI trigger state is activated (via DCI or MAC signaling), implicit beam switching may also be indicated for the CSI report associated with the CSI trigger state. The UE 120 may perform implicit beam switching when indicated to perform CSI measurement or CSI report based at least in part on the CSI trigger state with the implicit beam switching indicator.

In some aspects, the implicit beam switching indication 305 may be included in DCI for a CSI request, such as shown by reference number 320 and described in more detail below. For example, a CSI request may request that the UE 120 provide a CSI report. In this example, the CSI request may include a field (e.g., a field for a CSI request and an implicit beam switch indicator) or another form of indication that implicit beam switching is allowed for the UE 120. For example, a particular value in the field of the DCI request may indicate a CSI request that is associated with implicit beam switching. As another example, one or more codepoints of a CSI request in DCI may be configured to be mapped with a CSI request and an implicit beam switch indicator. When the UE 120 receives a DCI indicating a codepoint mapped with a CSI request and an implicit beam switch indicator, the UE 120 may perform implicit beam switching when indicated to perform CSI measurement or CSI reporting based at least in part on the CSI request with the implicit beam switching indicator.

In some aspects, the implicit beam switching indication 305 may be included in a dedicated DCI field. For example, the base station 110 may transmit DCI (such as the DCI shown by reference number 315) that includes a field for the implicit beam switching indication 305. The DCI can include a dedicated bit for the purpose of the implicit beam switching indication 305 (as shown by reference number 315) or can be DCI associated with another purpose (such as the CSI request shown by reference number 320).

As shown by reference number 310, the base station 110 may provide configuration information (such as using the communication manager 150 or the configuration component 710). The UE 120 may receive the configuration information, such as using the communication manager 140 or the reception component 602. As shown, the configuration information may include a CSI report configuration. The CSI report configuration may indicate that the UE 120 is to identify and report a best reference signal index, where the reference signal index may correspond to a CSI-RS or an SSB. For example, the CSI report configuration may be configured with a report quantity set to “cri-RSRP”, which indicates that the UE 120 should generate a CSI report that includes a CSI-RS resource indicator (CRI) to identify a strongest CSI-RS (which corresponds to a selected beam). The CSI report configuration may also indicate to report a measurement value associated with the strongest CSI-RS (such as a reference signal received power (RSRP) value). In some aspects, as shown, the configuration information may include a CSI trigger state, as described in more detail above. In some aspects, one or more of the CSI report configuration or the CSI trigger state may include an implicit beam switching indication 305, as described in more detail above.

In some aspects, as shown by reference number 315, the base station 110 may transmit dedicated DCI. The dedicated DCI may include an implicit beam switching indication 305. In some other aspects, the implicit beam switching indication 305 may not be included in the dedicated DCI (and the dedicated DCI may not be transmitted). For example, the implicit beam switching indication 305 may be included in or associated with one or more of the CSI report configuration, the CSI trigger state, or the CSI request.

As shown by reference number 320, the base station 110 may transmit (e.g., using communication manager 150 or transmission component 704), and the UE 120 may receive (e.g., using communication manager 140 or reception component 702), a CSI request. For example, the base station 110 may transmit the CSI request via DCI or via MAC signaling. The CSI request may request that the UE 120 determine CSI and transmit a CSI report in accordance with the CSI report configuration shown by reference number 310. In some aspects, the CSI request may activate a CSI trigger state configured for the UE 120.

As shown by reference number 325, the UE 120 (e.g., using communication manager 140 and/or a beam switch component) and the base station 110 may perform a beam management procedure, such as a beam measurement procedure or a beam report procedure, in accordance with the CSI request. The beam management procedure may include the base station 110 performing beam sweeping over multiple transmit (Tx) beams. The base station 110 may transmit a CSI-RS using each transmit beam. To enable the UE 120 to perform receive (Rx) beam sweeping, the base station may use a transmit beam to transmit (e.g., with repetitions) each CSI-RS at multiple times within the same reference signal resource set so that the UE 120 can sweep through receive beams in multiple transmission instances. For example, if the base station 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the base station 110, the UE 120 may perform beam sweeping through the receive beams of the UE 120. As a result, the beam management procedure may enable the UE 120 to measure a CSI-RS on different transmit beams using different receive beams to support selection of base station 110 transmit beams/UE 120 receive beam(s) beam pair(s). While example 300 has been described in connection with CSI-RSs, the beam management procedure may also use SSBs for beam management in a similar manner as described above.

As shown by reference number 330, the UE 120 may select (e.g., using communication manager 140 or beam switch component 608) a beam. For example, the UE 120 may identify a CSI-RS with a best measurement (e.g., a highest RSRP, a highest signal to interference plus noise ratio (SINR), a highest reference signal received quality (RSRQ), or the like). The UE 120 may identify a downlink beam on which the CSI-RS with the best measurement was transmitted. The UE 120 may select the downlink beam for implicit beam switching.

In some aspects, the UE 120 may select the beam based at least in part on a filtering configuration. In some aspects, the base station 110 may configure the filtering configuration for the UE 120. In some other aspects, the UE 120 may be preconfigured with the filtering configuration (such as based at least in part on a wireless communication standard or an implementation of the UE 120). The filtering configuration may be a time domain filtering configuration. In some aspects, the filtering configuration may enable the UE 120 to avoid a ping-pong effect, whereby the UE 120 switches back and forth between a first beam and a second beam due to measurements associated with the first beam and the second beam repeatedly becoming best measurements.

In some aspects, the filtering configuration may be associated with a periodic CSI-RS. For example, a candidate beam may be measured and associated with a time filtering configuration when a reference signal (RS) for the beam is periodical. The time filtering configuration may be associated with a coefficient alpha. The coefficient may assign a relative weight to a prior reference signal measurement and to a most recent reference signal measurement. For example, a time filtered CSI-RS measurement for a periodic CSI-RS transmitted at time1 and time2 may be defined as:

(1−alpha)*RS@time1+alpha*RS@time2,

where “RS@time1” is an unfiltered CSI-RS measurement at time1 and “RS@time2” is an unfiltered CSI-RS measurement at time2. As another example, the candidate beam may be measured and associated with a counter when the CSI-RS is periodical. For example, a CSI-RS may be selected as a selected CSI-RS based at least in part on the CSI-RS being associated with a measurement that satisfies a threshold at least a number of times specified by the counter. In some aspects, the counter may be predetermined at the UE. For example, the counter may be fixed, or may be configured by the RRC signaling.

In some aspects, the filtering configuration may be based at least in part on the CSI report configuration. For example, the CSI report via which the selected beam is to be reported may be configured with a parameter “timeRestrictionForChannelMeasurements” set as “not configured.” Setting this parameter as “not configured” may enable the UE 120 to perform time-domain filtering according to the UE 120's implementation. For example, if the UE 120 is not configured with the parameter timeRestrictionForChannelMeasurements in CSI-ReportConfig, the UE 120 may derive the channel measurements for computing L1-RSRP value reported in uplink slot n based on only the SS/PBCH or non zero power (NZP) CSI-RS, no later than the CSI reference resource, associated with the CSI resource setting. Thus, the BS 110 may indicate that the UE 120 can perform time domain filtering of the measurements associated with the CSI-RSs according to the UE 120's configuration, which conserves signaling resources associated with the BS 110 configuring the UE 120's filtering configuration.

In some aspects, the selected beam (based at least in part on the CSI report used for implicit beam switching) can be applicable for any downlink channel, any uplink channel, or any reference signal usable by the UE 120. For example, for a beam associated with an RS in a CSI report used for implicit beam switching, the applicable target channel or reference signal for the beam may be all uplink and downlink channels. In some aspects, the selected beam associated with an RS in a CSI report used for implicit beam switching can be applicable for a set of downlink channels, uplink channels, and/or reference signals. For example, the set of downlink channels, uplink channels, or reference signals may be indicated via RRC signaling or MAC signaling. As another example, the set of downlink channels, uplink channels, or reference signals may be based at least in part on a transmit/receive point (TRP) identifier (such as a CORESETPoolIndex identifier) of the base station 110. In some aspects, the applicable target channels and/or reference signals for a beam associated with an RS in a CSI report used for implicit beam switching may be determined based at least in part on a transmission configuration indicator (TCI) state or spatial relation information that has a source RS quasi-colocated (QCLed) to the beam associated with an RS in a CSI report used for implicit beam switching. For example, the applicable target channels and/or reference signals may be the ones applicable for the TCI state or the spatial relation information with a source RS QCLed to the beam associated with an RS in a CSI report used for implicit beam switching. In some aspects, the TCI state may be a unified TCI. A unified TCI is a TCI that can indicate a source RS to determine either or both of an transmit filter for uplink transmission and a QCL information for downlink reception.

As shown by reference number 335, the UE 120 may transmit (e.g., using communication manager 140 or transmission component 604) a CSI report indicating the selected beam. For example, the UE 120 may transmit information indicating an identifier of the selected beam, such as a beam identifier, a reference signal index, or the like. In some aspects, the UE 120 may transmit the CSI report in accordance with the CSI report configuration. For example, the UE 120 may indicate a number of selected RSs as configured by the CSI report configuration, where each RS may be associated with a beam. In some aspects, in the case of implicit beam switching, the CSI report may be configured to report only a single beam (such as an RS index used to identify the beam and a metric associated with the selected RS), which the UE 120 and the base station 110 may use for implicit beam switching. In some other aspects, the CSI report may be configured to report multiple beams (thus, multiple RS indices, and each RS is associated with the metric such as L1-RSRP, or L1-SINR). In some examples, the UE 120 and the base station 110 may use one reference signal (i.e., beam) based on some rule for the implicit beam switch (so the selected beam may correspond to the reference signal with the best reported metric, e.g., highest RSRP). In some examples, the UE 120 and the base station 110 may use one reference signal (i.e., beam) with a best reported metric for the implicit beam switch (so the selected beam may correspond to the reference signal with the best reported metric, e.g., highest RSRP). In some other examples, the UE 120 may indicate, in the CSI report, which beam, of multiple beams indicated in the CSI report, is the selected beam for the implicit beam switch. For example, the CSI report may include an indication of which beam is the selected beam, or the selected beam may be located at a predetermined place in the CSI report (e.g., a first location, etc.).

As shown by reference number 340, the UE 120 may determine (e.g., using communication manager 140 or reception component 602) that no cancellation indication is received from the base station 110. A cancellation indication indicates to cancel an implicit beam switch to a selected beam. In some aspects, a cancellation indication may be based at least in part on the base station 110 detecting a transmission error in the CSI report. Thus, the base station 110 may cancel the implicit beam switch. In this case, the cancellation indication may be considered a beam cancellation.

In some aspects, the cancellation indication may be based at least in part on a time offset. If the UE 120 does not receive the cancellation within the time offset after transmitting the CSI report used for implicit beam switching, the UE 120 may proceed with the implicit beam switch. In some aspects, the cancellation indication may be or may be included in a CSI request for the same aperiodic CSI report as shown by reference number 335. In some aspects, the cancellation indication may be or may be included in a CSI request for any aperiodic CSI report on the same bandwidth part or the same component carrier as the CSI report shown by reference number 335. In some aspects, the cancellation indication may be or may be included in any CSI request for updating a measurement on a beam to be implicitly switched (e.g., the selected beam or a beam used by the UE 120 prior to switching to the selected beam).

In some aspects, the time offset may be defined as a number X of symbols or slots, where X is an integer. A length of a symbol or slot is dependent on the subcarrier spacing (SCS) of the subcarrier or bandwidth part associated with the symbol or slot. In some aspects, the UE 120 may be associated with multiple SCSs, such as based at least in part on the UE 120 being configured with multiple carriers or bandwidth parts.

In some aspects, X may use a smallest SCS of the UE 120. For example, X may use a smallest SCS of the DCI that carries the CSI request shown by reference number 320 and the physical uplink shared channel (PUSCH) that carries the CSI report shown by reference number 335. As another example, X may use a smallest SCS of the DCI that carries the CSI request shown by reference number 320 and a CSI channel measurement resource (CSI-CMR) that was used to determine measurements regarding the CSI-RS of the selected beam. As yet another example, X may use a smallest SCS of the DCI that carries the CSI request shown by reference number 320, the PUSCH that carries the CSI report shown by reference number 335, and a CSI-CMR that was used to determine measurements regarding the CSI-RS of the selected beam.

In some aspects, X may use a largest SCS of the UE 120. For example, X may use a largest SCS of the DCI that carries the CSI request shown by reference number 320 and the PUSCH that carries the CSI report shown by reference number 335. As another example, X may use a largest SCS of the DCI that carries the CSI request shown by reference number 320 and a CSI channel measurement resource (CSI-CMR) that was used to determine measurements regarding the CSI-RS of the selected beam. As yet another example, X may use a largest SCS of the DCI that carries the CSI request shown by reference number 320, the PUSCH that carries the CSI report shown by reference number 335, and a CSI-CMR that was used to determine measurements regarding the CSI-RS of the selected beam.

As shown by reference numbers 345 and 350, the UE 120 and the base station 110 may switch to the selected beam (e.g., using communication manager 140/150 or beam switch component 608/708). For example, the UE 120 and the base station 110 may switch to the beam if no cancellation indication is transmitted (and received) within the time offset. To switch to the selected beam, the UE 120 and the base station 110 may activate a downlink beam (e.g., a transmit beam at the base station 110 and a receive beam at the UE 120) defined by the selected beam. The UE 120 and the base station 110 may switch to the beam without transmitting or receiving an explicit beam indication or activation. If the cancellation indication is received by the UE 120, then the UE 120 and the base station 110 may not perform the implicit beam switch. Thus, the UE 120 and the base station 110 may be said to selectively switch to the selected beam.

In some aspects, the UE 120 may switch to the selected beam and/or select the selected beam based at least in part on a reported metric of the selected beam satisfying a threshold. For example, the reported metric may identify a measurement associated with the selected beam (e.g., an RSRP, an SINR, an RSRP, or the like). In some aspects, the UE 120 may switch to the selected beam and/or select the selected beam based at least in part on the reported metric (e.g., a reported beam quality) being better than a threshold. In some aspects, the UE 120 may switch to the selected beam and/or select the selected beam based at least in part on the reported metric (e.g., a reported beam quality) being at least a threshold value better than another beam (e.g., an older beam). For example, the other beam may be a currently used beam for a control resource set (CORESET) with a lowest identifier, or may be a beam with an activated physical downlink shared channel (PDSCH) TCI state with a lowest codepoint identifier. If the reported metric fails to satisfy the above-described threshold, then the UE 120 and the base station 110 may not perform the implicit beam switch for the reported metric. Alternatively, the UE 120 may not select a beam as the selected beam if one or more of the above-described thresholds are not satisfied.

As indicated above, FIG. 3 is provided as an example. Other examples may differ from what is described with respect to FIG. 3.

FIG. 4 is a diagram illustrating an example process 400 performed, for example, by an apparatus of a UE, in accordance with the present disclosure. Example process 400 is an example where the apparatus of the UE (e.g., UE 120) performs operations associated with implicit beam switching.

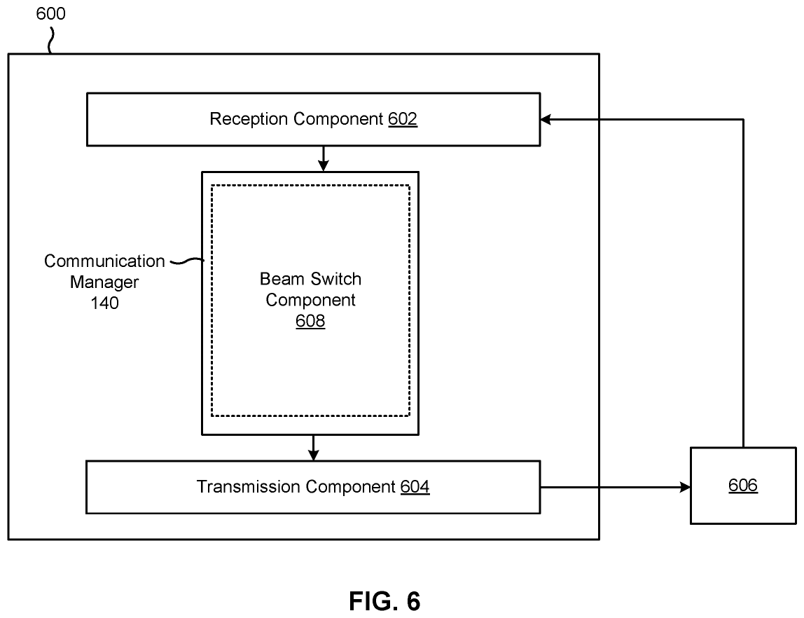

As shown in FIG. 4, in some aspects, process 400 may include receiving an indication that beam switching without an explicit beam indication or activation is allowed (block 410). For example, the apparatus (e.g., using communication manager 140 and/or reception component 602, depicted in FIG. 6) may receive an indication that beam switching without an explicit beam indication or activation is allowed, as described above, for example, in connection with the implicit beam switching indication 305 of FIG. 3.

As further shown in FIG. 4, in some aspects, process 400 may include selecting a selected beam (block 420). For example, the UE (e.g., using communication manager 140 and/or beam switch component 608, depicted in FIG. 6) may select a selected beam, as described in more detail, for example, in connection with reference number 330 of FIG. 3.

As further shown in FIG. 4, in some aspects, process 400 may include transmitting a CSI report identifying a selected beam (block 430). For example, the UE (e.g., using communication manager 140 and/or transmission component 604, depicted in FIG. 6) may transmit a CSI report identifying a selected beam, as described above, for example, in connection with reference number 335 of FIG. 3.

As further shown in FIG. 4, in some aspects, process 400 may include selectively switching to the selected beam in accordance with the indication (block 440). For example, the UE (e.g., using communication manager 140 and/or beam switch component 608, depicted in FIG. 6) may selectively switch to the selected beam in accordance with the indication, as described above, for example, in connection with reference number 345 of FIG. 3.

Process 400 may include additional aspects, such as any single aspect or any combination of aspects described below and/or in connection with one or more other processes described elsewhere herein.

In a first aspect, switching to the selected beam in accordance with the indication further comprises switching to the selected beam without receiving the explicit beam indication or activation. In a second aspect, alone or in combination with the first aspect, the indication is received in at least one of a CSI report configuration, a CSI trigger state, DCI associated with a CSI request, or a dedicated DCI field.

In a third aspect, alone or in combination with one or more of the first and second aspects, process 400 includes receiving (e.g., using communication manager 140 or the reception component 602 of FIG. 6), after transmitting the CSI report, a cancellation indication, and canceling switching to the selected beam in accordance with the cancellation indication. In a fourth aspect, alone or in combination with one or more of the first through third aspects, canceling switching to the selected beam is based at least in part on receiving the cancellation indication within a time offset of transmitting the CSI report. In a fifth aspect, alone or in combination with one or more of the first through fourth aspects, the cancellation indication comprises a CSI request.

In a sixth aspect, alone or in combination with one or more of the first through fifth aspects, selecting the selected beam is based at least in part on a filtering configuration. In a seventh aspect, alone or in combination with one or more of the first through sixth aspects, the filtering configuration is performed over a time period.

In an eighth aspect, alone or in combination with one or more of the first through seventh aspects, the CSI report is configured to report only a single beam. In a ninth aspect, alone or in combination with one or more of the first through eighth aspects, the CSI report is configured to report a plurality of beams, and the selected beam is indicated in the CSI report based at least in part on the selected beam being associated with a best reported metric. In a tenth aspect, alone or in combination with one or more of the first through ninth aspects, the CSI report is configured to report a plurality of beams, and the selected beam is indicated in the CSI report based at least in part on an identifier of a reference signal associated with the selected beam.

In an eleventh aspect, alone or in combination with one or more of the first through tenth aspects, the selected beam can be for any uplink channel or any downlink channel usable by the UE. In a twelfth aspect, alone or in combination with one or more of the first through eleventh aspects, the selected beam is for a configured set of at least one of one or more uplink channels, one or more downlink channels, or one or more reference signals. In a thirteenth aspect, alone or in combination with one or more of the first through twelfth aspects, the selected beam is for a channel or reference signal that is quasi-colocated with a reference signal associated with the selected beam. In a fourteenth aspect, alone or in combination with one or more of the first through thirteenth aspects, the channel or reference signal is quasi-colocated with the reference signal associated with the selected beam based at least in part on a unified transmission configuration indicator.

In a fifteenth aspect, alone or in combination with one or more of the first through fourteenth aspects, transmitting the CSI report identifying the selected beam further comprises transmitting the CSI report identifying the selected beam based at least in part on a reported metric of the selected beam satisfying a threshold. In a sixteenth aspect, alone or in combination with one or more of the first through fifteenth aspects, the threshold is relative to another beam of the UE. In a seventeenth aspect, alone or in combination with one or more of the first through sixteenth aspects, the other beam is one of a beam used for a control resource set with a lowest identifier, or a beam associated with an activated transmission configuration indicator state with a lowest codepoint identifier.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by an apparatus of a base station, in accordance with the present disclosure. Example process 500 is an example where the apparatus of the base station (e.g., base station 110) performs operations associated with implicit beam switching.

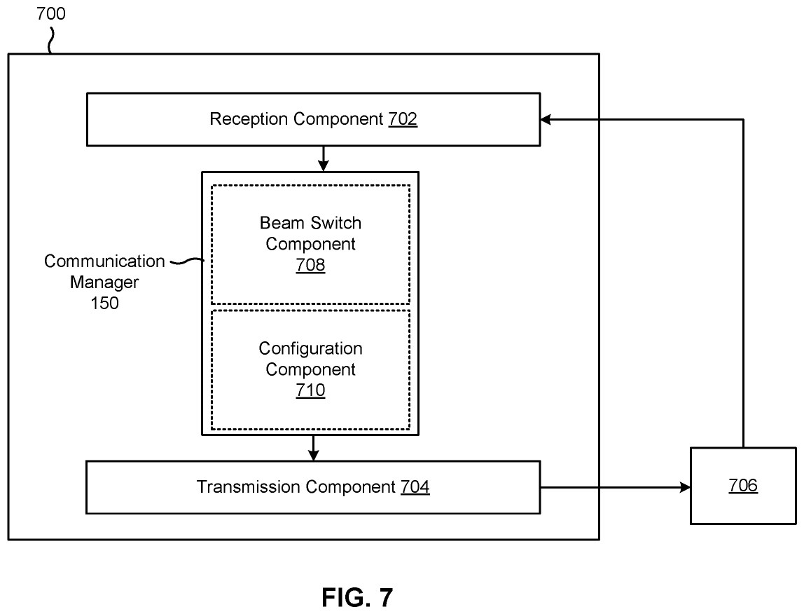

As shown in FIG. 5, in some aspects, process 500 may include transmitting, to a UE, an indication that beam switching without an explicit beam indication or activation is allowed (block 510). For example, the apparatus (e.g., using communication manager 150 and/or transmission component 704, depicted in FIG. 7) may transmit, to a UE, an indication that beam switching without an explicit beam indication or activation is allowed, as described above.

As further shown in FIG. 5, in some aspects, process 500 may include receiving a CSI report identifying a selected beam (block 520). For example, the apparatus (e.g., using communication manager 150 and/or reception component 702, depicted in FIG. 7) may receive a CSI report identifying a selected beam, as described above.

As further shown in FIG. 5, in some aspects, process 500 may include selectively switching to the selected beam in accordance with the indication (block 530). For example, the apparatus (e.g., using communication manager 150 and/or beam switch component 708, depicted in FIG. 7) may selectively switch to the selected beam in accordance with the indication, as described above.

Process 500 may include additional aspects, such as any single aspect or any combination of aspects described below and/or in connection with one or more other processes described elsewhere herein.

In a first aspect, switching to the selected beam in accordance with the indication further comprises switching to the selected beam without transmitting the explicit beam indication or activation. In a second aspect, alone or in combination with the first aspect, the indication is transmitted in at least one of a CSI report configuration, a CSI trigger state, DCI associated with a CSI request, or a dedicated DCI field.

In a third aspect, alone or in combination with one or more of the first and second aspects, process 500 includes transmitting (e.g., using communication manager 150 and/or transmission component 704, depicted in FIG. 7), after transmitting the CSI report, a cancellation indication indicating to cancel switching to the selected beam. In a fourth aspect, alone or in combination with one or more of the first through third aspects, canceling switching to the selected beam is based at least in part on transmitting the cancellation indication within a time offset of transmitting the CSI report. In a fifth aspect, alone or in combination with one or more of the first through fourth aspects, the cancellation indication comprises a CSI request.

In a sixth aspect, alone or in combination with one or more of the first through fifth aspects, process 500 includes configuring (e.g., using communication manager 150 and/or configuration component 710, depicted in FIG. 7), for the UE, a filtering configuration associated with selecting the selected beam. In a seventh aspect, alone or in combination with one or more of the first through sixth aspects, the filtering configuration is performed over a time period.

In an eighth aspect, alone or in combination with one or more of the first through seventh aspects, the CSI report is configured to report only a single beam. In a ninth aspect, alone or in combination with one or more of the first through eighth aspects, the CSI report is configured to report a plurality of beams, and the selected beam is indicated in the CSI report based at least in part on the selected beam being associated with a best reported metric. In a tenth aspect, alone or in combination with one or more of the first through ninth aspects, the CSI report is configured to report a plurality of beams, and the selected beam is indicated in the CSI report based at least in part on an identifier of a reference signal associated with the selected beam.

In an eleventh aspect, alone or in combination with one or more of the first through tenth aspects, the selected beam can be for any uplink channel or any downlink channel usable by the UE. In a twelfth aspect, alone or in combination with one or more of the first through eleventh aspects, the selected beam is for a configured set of at least one of one or more uplink channels, one or more downlink channels, or one or more reference signals. In a thirteenth aspect, alone or in combination with one or more of the first through twelfth aspects, the selected beam is for a channel or reference signal that is quasi-colocated with a reference signal associated with the selected beam. In a fourteenth aspect, alone or in combination with one or more of the first through thirteenth aspects, the channel or reference signal is quasi-colocated with the reference signal associated with the selected beam based at least in part on a unified transmission configuration indicator.

In a fifteenth aspect, alone or in combination with one or more of the first through fourteenth aspects, a reported metric of the selected beam satisfies a threshold.

In a sixteenth aspect, alone or in combination with one or more of the first through fifteenth aspects, the threshold is relative to another beam of the UE. In a seventeenth aspect, alone or in combination with one or more of the first through sixteenth aspects, the other beam is one of a beam used for a control resource set with a lowest identifier, or a beam associated with an activated transmission configuration indicator state with a lowest codepoint identifier.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication, in accordance with the present disclosure. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 140. The communication manager 140 may include a beam switch component 608, among other examples.

In some aspects, the apparatus 600 may be configured to perform one or more operations described herein in connection with FIG. 3. Additionally, or alternatively, the apparatus 600 may be configured to perform one or more processes described herein, such as process 400 of FIG. 4, or a combination thereof. In some aspects, the apparatus 600 and/or one or more components shown in FIG. 6 may include one or more components of the UE described in connection with FIG. 2. Additionally, or alternatively, one or more components shown in FIG. 6 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 606. In some aspects, the reception component 602 may include one or more antennas, a modem, a demodulator, a MIMO detector, a receive processor, a controller/processor, a memory, or a combination thereof, of the UE described in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modem, a modulator, a transmit MIMO processor, a transmit processor, a controller/processor, a memory, or a combination thereof, of the UE described in connection with FIG. 2. In some aspects, the transmission component 604 may be co-located with the reception component 602 in a transceiver.

The reception component 602 may receive an indication that beam switching without an explicit beam indication or activation is allowed. In some aspects, the beam switch component 608 may select a selected beam. The transmission component 604 may transmit a CSI report identifying a selected beam. The beam switch component 608 may selectively switch to the selected beam in accordance with the indication.

The reception component 602 may receive, after transmitting the CSI report, a cancellation indication. The beam switch component 608 may cancel the beam switch in accordance with the cancellation indication.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

FIG. 7 is a diagram of an example apparatus 700 for wireless communication, in accordance with the present disclosure. The apparatus 700 may be a base station, or a base station may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include the communication manager 150. The communication manager 150 may include one or more of a beam switch component 708 or a configuration component 710, among other examples.

In some aspects, the apparatus 700 may be configured to perform one or more operations described herein in connection with FIG. 3. Additionally, or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the base station described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a modem, a demodulator, a MIMO detector, a receive processor, a controller/processor, a memory, or a combination thereof, of the base station described in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the base station described in connection with FIG. 2. In some aspects, the transmission component 704 may be co-located with the reception component 702 in a transceiver.

The transmission component 704 may transmit, to a UE, an indication that beam switching without an explicit beam indication or activation is allowed. The reception component 702 may receive a CSI report identifying a selected beam. The beam switch component 708 may selectively switch to the selected beam in accordance with the indication.

The transmission component 704 may transmit, after transmitting the CSI report, a cancellation indication indicating to cancel the beam switch.

The configuration component 710 may configure, for the UE, a filtering configuration associated with selecting the selected beam.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a user equipment (UE), comprising: receiving an indication that beam switching without an explicit beam indication or activation is allowed; transmitting a channel state information (CSI) report identifying a selected beam; and selectively switching to the selected beam in accordance with the indication.
Aspect 2: The method of Aspect 1, wherein switching to the selected beam in accordance with the indication further comprises: switching to the selected beam without receiving the explicit beam indication or activation.
Aspect 3: The method of any of Aspects 1-2, wherein the indication is received in at least one of: a CSI report configuration, a CSI trigger state, downlink control information (DCI) associated with a CSI request, or a dedicated DCI field.
Aspect 4: The method of any of Aspects 1-3, further comprising: receiving, after transmitting the CSI report, a cancellation indication; and cancelling switching to the selected beam in accordance with the cancellation indication.
Aspect 5: The method of Aspect 4, wherein cancelling switching to the selected beam is based at least in part on receiving the cancellation indication within a time offset of transmitting the CSI report.
Aspect 6: The method of Aspect 5, wherein the cancellation indication comprises a CSI request.
Aspect 7: The method of any of Aspects 1-6, further comprising: selecting the selected beam.
Aspect 8: The method of Aspect 7, wherein selecting the selected beam is based at least in part on a filtering configuration.
Aspect 9: The method of Aspect 8, wherein the filtering configuration is performed over a time period.
Aspect 10: The method of any of Aspects 1-9, wherein the CSI report is configured to report only a single beam.
Aspect 11: The method of any of Aspects 1-9, wherein the CSI report is configured to report a plurality of beams, and wherein the selected beam is indicated in the CSI report based at least in part on the selected beam being associated with a best reported metric.
Aspect 12: The method of any of Aspects 1-9, wherein the CSI report is configured to report a plurality of beams, and wherein the selected beam is indicated in the CSI report based at least in part on an identifier of a reference signal associated with the selected beam.
Aspect 13: The method of any of Aspects 1-12, wherein the selected beam can be for any uplink channel or any downlink channel usable by the UE.
Aspect 14: The method of any of Aspects 1-12, wherein the selected beam is for a configured set of at least one of: one or more uplink channels, one or more downlink channels, or one or more reference signals.
Aspect 15: The method of any of Aspects 1-12, wherein the selected beam is for a channel or reference signal that is quasi-colocated with a reference signal associated with the selected beam.
Aspect 16: The method of Aspect 15, wherein the channel or reference signal is quasi-colocated with the reference signal associated with the selected beam based at least in part on a unified transmission configuration indicator.
Aspect 17: The method of any of Aspects 1-16, wherein transmitting the CSI report identifying the selected beam further comprises: transmitting the CSI report identifying the selected beam based at least in part on a reported metric of the selected beam satisfying a threshold.
Aspect 18: The method of Aspect 17, wherein the threshold is relative to another beam of the UE.
Aspect 19: The method of Aspect 18, wherein the other beam is one of: a beam used for a control resource set with a lowest identifier, or a beam associated with an activated transmission configuration indicator state with a lowest codepoint identifier.
Aspect 20: A method of wireless communication performed by a base station, comprising: transmitting, to a user equipment (UE), an indication that beam switching without an explicit beam indication or activation is allowed; receiving a channel state information (CSI) report identifying a selected beam; and selectively switching to the selected beam in accordance with the indication.
Aspect 21: The method of Aspect 20, wherein switching to the selected beam in accordance with the indication further comprises: switching to the selected beam without transmitting the explicit beam indication or activation.
Aspect 22: The method of any of Aspects 20-21, wherein the indication is transmitted in at least one of: a CSI report configuration, a CSI trigger state, downlink control information (DCI) associated with a CSI request, or a dedicated DCI field.
Aspect 23: The method of any of Aspects 20-22, further comprising: transmitting, after transmitting the CSI report, a cancellation indication indicating to cancel switching to the selected beam.
Aspect 24: The method of Aspect 23, wherein cancelling switching to the selected beam is based at least in part on transmitting the cancellation indication within a time offset of transmitting the CSI report.
Aspect 25: The method of Aspect 24, wherein the cancellation indication comprises a CSI request.
Aspect 26: The method of any of Aspects 20-25, further comprising: configuring, for the UE, a filtering configuration associated with selecting the selected beam.
Aspect 27: The method of Aspect 26, wherein the filtering configuration is performed over a time period.
Aspect 28: The method of any of Aspects 20-27, wherein the CSI report is configured to report only a single beam.
Aspect 29: The method of any of Aspects 20-27, wherein the CSI report is configured to report a plurality of beams, and wherein the selected beam is indicated in the CSI report based at least in part on the selected beam being associated with a best reported metric.
Aspect 30: The method of any of Aspects 20-27, wherein the CSI report is configured to report a plurality of beams, and wherein the selected beam is indicated in the CSI report based at least in part on an identifier of a reference signal associated with the selected beam.
Aspect 31: The method of any of Aspects 20-30, wherein the selected beam can be for any uplink channel or any downlink channel usable by the UE.
Aspect 32: The method of any of Aspects 20-31, wherein the selected beam is for a configured set of at least one of: one or more uplink channels, one or more downlink channels, or one or more reference signals.
Aspect 33: The method of any of Aspects 20-32, wherein the selected beam is for a channel or reference signal that is quasi-colocated with a reference signal associated with the selected beam.
Aspect 34: The method of Aspect 33, wherein the channel or reference signal is quasi-colocated with the reference signal associated with the selected beam based at least in part on a unified transmission configuration indicator.
Aspect 35: The method of any of Aspects 20-34, wherein a reported metric of the selected beam satisfies a threshold.
Aspect 36: The method of Aspect 35, wherein the threshold is relative to another beam of the UE.
Aspect 37: The method of Aspect 36, wherein the other beam is one of: a beam used for a control resource set with a lowest identifier, or a beam associated with an activated transmission configuration indicator state with a lowest codepoint identifier.
Aspect 38: An apparatus for wireless communication at a device, comprising a processor; memory coupled with the processor; and instructions stored in the memory and executable by the processor to cause the apparatus to perform the method of one or more of Aspects 1-37.
Aspect 39: A device for wireless communication, comprising a memory and one or more processors coupled to the memory, the one or more processors configured to perform the method of one or more of Aspects 1-37.
Aspect 40: An apparatus for wireless communication, comprising at least one means for performing the method of one or more of Aspects 1-37.
Aspect 41: A non-transitory computer-readable medium storing code for wireless communication, the code comprising instructions executable by a processor to perform the method of one or more of Aspects 1-37.
Aspect 42: A non-transitory computer-readable medium storing a set of instructions for wireless communication, the set of instructions comprising one or more instructions that, when executed by one or more processors of a device, cause the device to perform the method of one or more of Aspects 1-37.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
receive an indication that beam switching without an explicit beam indication or activation is allowed;
transmit a channel state information (CSI) report identifying a selected beam; and
selectively switch to the selected beam in accordance with the indication.

2. The apparatus of claim 1, wherein the one or more processors, to switch to the selected beam in accordance with the indication, are configured to:
switch to the selected beam without receiving the explicit beam indication or activation.

3. The apparatus of claim 1, wherein the one or more processors are further configured to:
receive, after transmitting the CSI report, a cancellation indication; and
cancel switching to the selected beam in accordance with the cancellation indication.

4. The apparatus of claim 3, wherein cancelling switching is based at least in part on receiving the cancellation indication within a time offset of transmitting the CSI report.

5. The apparatus of claim 1, wherein the one or more processors are further configured to:
select the selected beam.

6. The apparatus of claim 5, wherein selecting the selected beam is based at least in part on a filtering configuration.

7. The apparatus of claim 1, wherein the one or more processors are further configured to report only a single beam.

8. The apparatus of claim 1, wherein the CSI report is configured to report a plurality of beams, and wherein the selected beam is indicated in the CSI report based at least in part on the selected beam being associated with a best reported metric.

9. The apparatus of claim 1, wherein the CSI report is configured to report a plurality of beams, and wherein the selected beam is indicated in the CSI report based at least in part on an identifier of a reference signal associated with the selected beam.

10. The apparatus of claim 1, wherein the selected beam can be for any uplink channel or any downlink channel usable by the UE.

11. The apparatus of claim 1, wherein the selected beam is for a configured set of at least one of:
one or more uplink channels,
one or more downlink channels, or
one or more reference signals.

12. The apparatus of claim 1, wherein the selected beam is for a channel or reference signal that is quasi-colocated with a reference signal associated with the selected beam.

13. The apparatus of claim 1, wherein the one or more processors, to transmit the CSI report identifying the selected beam, are configured to:
transmit the CSI report identifying the selected beam based at least in part on a reported metric of the selected beam satisfying a threshold.

14. An apparatus for wireless communication at a base station, comprising:
a memory; and
one or more processors, coupled to the memory, configured to:
transmit, to a user equipment (UE), an indication that beam switching without an explicit beam indication or activation is allowed;
receive a channel state information (CSI) report identifying a selected beam; and
selectively switch to the selected beam in accordance with the indication.

15. The apparatus of claim 14, wherein the one or more processors are further configured to:
transmit, after transmitting the CSI report, a cancellation indication indicating to cancel switching to the selected beam.

16. The apparatus of claim 14, wherein the one or more processors are further configured to:
configure, for the UE, a filtering configuration associated with selecting the selected beam.

17. The apparatus of claim 14, wherein a reported metric of the selected beam satisfies a threshold.

18. The apparatus of claim 17, wherein the threshold is relative to another beam of the UE.

19. The apparatus of claim 18, wherein the other beam is one of:
a beam used for a control resource set with a lowest identifier, or
a beam associated with an activated transmission configuration indicator state with a lowest codepoint identifier.

20. A method of wireless communication performed by a user equipment (UE), comprising:
receiving an indication that beam switching without an explicit beam indication or activation is allowed;
transmitting a channel state information (CSI) report identifying a selected beam; and
selectively switching to the selected beam in accordance with the indication.

21. The method of claim 20, wherein switching to the selected beam in accordance with the indication further comprises:
switching to the selected beam without receiving the explicit beam indication or activation.

22. The method of claim 20, further comprising:
receiving, after transmitting the CSI report, a cancellation indication; and
cancelling switching to the selected beam in accordance with the cancellation indication.

23. The method of claim 20, further comprising:
selecting the selected beam.

24. The method of claim 20, wherein the CSI report is configured to report only a single beam.

25. The method of claim 20, wherein the CSI report is configured to report a plurality of beams, and wherein the selected beam is indicated in the CSI report based at least in part on the selected beam being associated with a best reported metric.

26. The method of claim 20, wherein the CSI report is configured to report a plurality of beams, and wherein the selected beam is indicated in the CSI report based at least in part on an identifier of a reference signal associated with the selected beam.

27. A method of wireless communication performed by a base station, comprising:
transmitting, to a user equipment (UE), an indication that beam switching without an explicit beam indication or activation is allowed;
receiving a channel state information (CSI) report identifying a selected beam; and
selectively switching to the selected beam in accordance with the indication.

28. The method of claim 27, wherein switching to the selected beam in accordance with the indication further comprises:
switching to the selected beam without transmitting the explicit beam indication or activation.

29. The method of claim 27, further comprising:
transmitting, after transmitting the CSI report, a cancellation indication indicating to cancel the switch.

30. The method of claim 27, further comprising:
configuring, for the UE, a filtering configuration associated with selecting the selected beam.
